(19) United States
(12) Patent Application Publication
(10) Pub. No.: US 2022/0316630 A1
(43) Pub. Date: Oct. 6, 2022

(54) Fitting and Gasket

(71) Applicant: Victaulic Company, Easton, PA (US)

(72) Inventors: Nicholas Barbour, Quakertown, PA (US); Scott D. Madara, Nazareth, PA (US); Matthew A. Bowman, Palmer, PA (US)

(21) Appl. No.: 17/708,135

(22) Filed: Mar. 30, 2022

Related U.S. Application Data
(60) Provisional application No. 63/171,103, filed on Apr. 6, 2021.

(51) Int. Cl. F16L 15/04; A62C 35/68; B05B 15/65

(52) U.S. Cl. CPC F16L 15/04; A62C 35/68; B05B 15/65

(57) ABSTRACT

A fitting has a conduit with a bore defined by a surface facing an axis coaxially located with respect to the bore. The surface may have three portions including a conical portion located proximate to the inlet of the conduit, a threaded portion located proximate to the outlet of the conduit and a cylindrical portion located between the conical and threaded portions. A gasket is positioned within the conduit. The gasket has an outer surface and an inner surface facing the axis. The gasket inner surface has angularly oriented lands. One of the lands faces the outlet and is engaged by a threaded component received by the threaded portion. Engagement between the component and the land compresses the gasket radially outwardly and longitudinally within the conduit. An angularly oriented shoulder guides the gasket into a redirection space defined by the conical portion (when present) as it deforms.

### CROSS REFERENCE TO RELATED APPLICATIONS

This application is based upon and claims benefit of priority to U.S. Provisional Application No. 63/171,103, filed Apr. 6, 2021, which application is hereby incorporated by reference herein.

### FIELD OF THE INVENTION

This invention relates to gaskets and threaded fittings for forming fluid tight joints.

### BACKGROUND

The connection of threaded fluid control components such as sprinklers to tapered threaded fittings in a fire suppression system traditionally requires a sealing compound (known as “pipe dope”) to be applied to the male threads of the component to ensure a fluid tight joint at the threaded engagement between fitting and component. A more modern approach to ensure a fluid tight joint involves wrapping the male threads in a sealing tape comprising polytetrafluoroethylene before engaging the component with the fitting. Some have even gone as far as to apply pipe dope to a taped fitting.

Those steps, intended to produce a fluid tight joint, require additional time, effort and expense to effect. Further, even with care taken in the implementation of those steps, fit up of sprinklers to fittings still results in some percentage of leaking joints which require correction. There is clearly an opportunity to improve the installation of threaded components by eliminating such steps while still maintaining a fluid tight joint.

### SUMMARY

The invention concerns a fitting. An example fitting may comprise a reducer fitting, an elbow fitting, a tee fitting or a cross fitting. In an example embodiment the fitting comprises a conduit having an inlet and an outlet connected to one another via a bore extending therebetween. The conduit comprises a surface surrounding and defining the bore. A first portion of the surface is positioned proximate to the outlet. The first portion comprises threads extending along the bore. The threads may comprise straight threads, and the straight threads may comprise NPSL threads for example. In another example the threads may comprise tapered threads. A second portion of the surface is positioned between the first portion and the inlet. The second portion defines a truncated cone. A base of the cone is positioned proximate to the inlet. The cone defines a redirection space within the bore. A shoulder surface is positioned at the inlet. The shoulder surface projects into the bore. The shoulder surface faces the outlet and is oriented transversely and non-perpendicularly with respect to an axis arranged coaxially with the bore.

In a further example the fitting comprises a third portion of the surface positioned between the first and second portions thereof. The third portion defines a cylindrical shape.

In an example the fitting further comprises a gasket positioned within the bore between the first and second portions of the surface. The gasket comprises an outer surface facing away from the axis and an inner surface facing the axis. The outer surface of the gasket may have a length greater than a length of the third portion of the surface. The outer surface of the gasket has a cylindrical shape. In an example embodiment the inner surface of the gasket comprises a first land positioned proximate to the first portion of the surface. The first land is angularly oriented with respect to the axis such that an inner diameter of the gasket is greater at a point proximate to the first portion of the surface than a point distal thereto. Further by way of example the inner surface of the gasket may further comprise a second land positioned proximate to the second portion of the surface. The second land is angularly oriented with respect to the axis such that an inner diameter of the gasket is greater at a point proximate to the inlet than a point distal thereto. In an example embodiment the second land has a surface area greater than a surface area of the first land.

By way of example the fitting according to the invention may further comprise a sprinkler or other fluid control component threadedly received within the bore at the outlet, an end of the sprinkler engaging the first land. The sprinkler or other fluid control component may comprise straight threads and the straight threads may comprise NPSL threads. In another example the sprinkler or other fluid control component may comprise tapered threads. In an example embodiment the end of the sprinkler may comprise a chamfer. The chamfer may have an angular orientation the same as that of the first land. Engagement between the sprinkler and the first land compresses the gasket against the shoulder surface.

Another example fitting according to the invention comprises a conduit having an inlet and an outlet connected to one another via a bore extending therebetween. The conduit comprises a surface surrounding and defining the bore. A first portion of the surface, positioned proximate to the outlet, comprising threads extending along the bore. A second portion of the surface, positioned between the first portion and the inlet, defines a cylindrical shape. A shoulder surface is positioned at the inlet and projects into the bore. The shoulder surface faces the outlet and is oriented transversely and non-perpendicularly with respect to an axis arranged coaxially with the bore. The example fitting may comprise a reducer fitting and an escutcheon positioned at the outlet of the fitting.

The invention also encompasses a method of sealing a threaded sprinkler to a fitting defining a conduit having a threaded outlet using a gasket positioned within the conduit. In an example embodiment the method comprises:
rotating the threaded sprinkler within the threaded outlet so as to advance the sprinkler into engagement with an angularly oriented land of the gasket;
continue rotating the threaded sprinkler so as to compress the gasket both longitudinally within the conduit and radially outwardly against the conduit.

The method may further comprise engaging threads of the threaded sprinkler with the land.

### BRIEF DESCRIPTION OF THE DRAWINGS

FIG. 1 is a longitudinal sectional view of an example fitting and gasket according to the invention engaged with a sprinkler;

FIG. 2 is a longitudinal sectional view of a portion of the fitting shown in FIG. 1 on an enlarged scale;

FIG. 3 is a longitudinal sectional view of the example gasket shown in FIG. 1 on an enlarged scale;

FIGS. 4-7 are longitudinal sectional views illustrating installation of a component into the fitting according to the invention shown in FIG. 1; and

FIGS. 8-14 are longitudinal sectional views of different example embodiments of fittings according to the invention.

### DETAILED DESCRIPTION

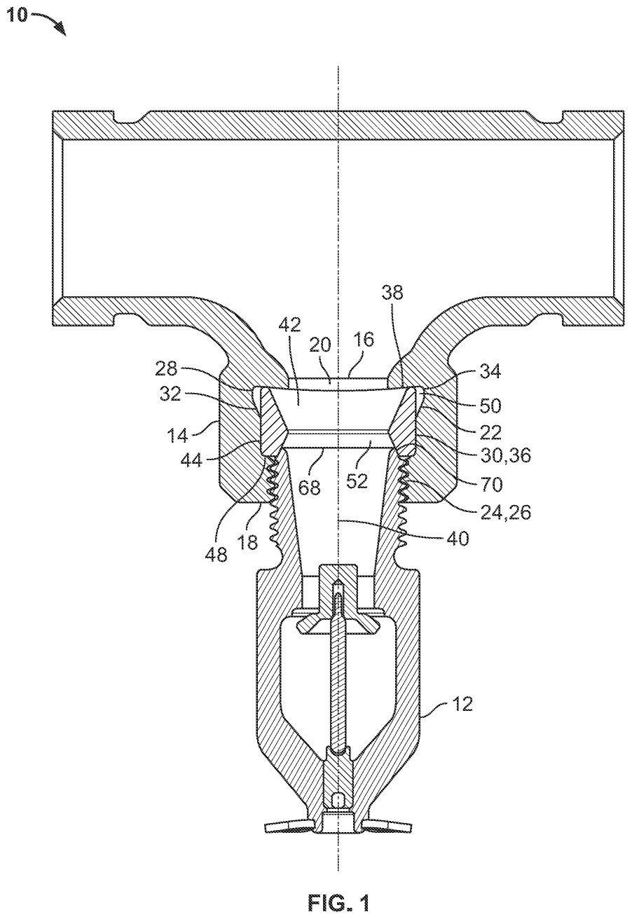

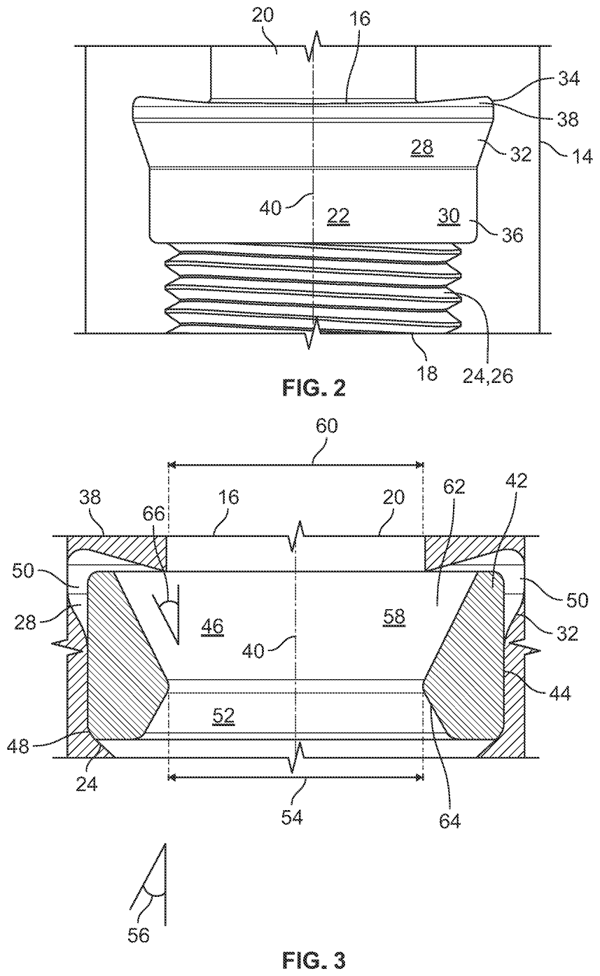

FIG. 1 shows an example embodiment of a fitting 10 according to the invention. In this example the fitting 10 is a “Tee” for connecting fluid control devices, such as the example sprinkler 12 in a piping run (not shown). Example fitting 10 comprises a conduit 14 having an inlet 16 and an outlet 18 connected to one another via a bore 20. As shown in FIG. 2, conduit 14 comprises a surface 22 surrounding and defining the bore 20. A first portion 24 of the surface 22 positioned proximate to the outlet 18 comprises female threads 26 extending along the bore 20. In this example, threads 26 are straight threads such as NPSL threads, which may be advantageously used to connect fitting 10 with fluid control devices such as sprinklers, which may have straight male threads. However, threads 26 could also be tapered threads. A second portion 28 of the surface 22 is positioned between the first portion 24 and the inlet 16. A third portion 30 of the surface 22 may be positioned between the first and second portions 24 and 28. The second portion 28 of surface 22 advantageously defines a truncated cone 32. The base 34 of the cone 32 is positioned proximate to the inlet 16. When present, the third portion 30 defines a substantially cylindrical shape 36.

A shoulder surface 38 is positioned at the inlet 16. Shoulder surface 38 projects into the bore 20 and faces the outlet 18. Shoulder surface 38 is oriented transversely and non-perpendicularly with respect to an axis 40 arranged coaxially with the bore 20 thereby providing a dovetail shape to the second portion 28 of surface 22 when viewed in longitudinal section as shown in FIGS. 1 and 2. This angular orientation of shoulder surface 38 guides the deformation behavior of a gasket 42 positioned within the bore 20 between the first and second portions 24 and 28 of surface 22 as described below.

Gasket 42 is advantageously formed of an elastomer such as EPDM and, as shown in FIG. 3, comprises an outer surface 44 facing away from the axis 40 and an inner surface 46 facing the axis. In this example embodiment the outer surface 44 has a cylindrical shape with a radius of curvature substantially matched to that of the third portion 30 of surface 22. As shown in FIG. 1, the outer surface 44 overlaps both the third and second portions 30, 28 of the surface 22, the length of the outer surface 44 of gasket 42 being greater than the length of the third portion 30 of surface 22. Gasket 42 is seated between the shoulder surface 38 and an undercut 48 marking a boundary between the first and third portions 24 and 30 of surface 22. Note that the truncated cone 32 defined by second portion 28 defines a redirection space 50 into which the gasket may deform when compressed.

As shown in FIG. 3, the inner surface 46 of the gasket 42 comprises a first land 52 positioned proximate to the first portion 24 of surface 22 when installed in bore 20. The first land 52 is angularly oriented with respect to the axis 40 such that an inner diameter 54 of the gasket is greater at a point proximate to the first portion 24 than a point distal thereto. For a practical design, orientation angles 56 of first land 52 may range from 25° to 50° with an angle from about 30°-45° being considered advantageous.

As further shown in FIG. 3, the inner surface 46 of the gasket 42 may further comprise a second land 58 positioned proximate to the second portion 28 of surface 22. In this example the second land 58 is also angularly oriented with respect to the axis 40 but with a slope opposite of the first land such that an inner diameter 60 of the gasket 42 is greater at a point proximate to the inlet 16 than a point distal thereto. To provide pressure responsiveness to gasket 42 the second land 58 has a surface area 62 greater than a surface area 64 of the first land 52. Orientation angles 66 of the second land may range from 20° to 60° with an angle of about 25° being considered advantageous for a practical design.

As shown in FIG. 1, the fitting 10 and gasket 42 may be used to attach tapered threaded sprinkler 12 or another fluid control component in a piping network of a fire suppression system for example. Sprinkler 12 is threadedly received within the bore 20 at the outlet 18, an end 68 of the sprinkler engaging the first land 52. The end 68 of the sprinkler 12 usually comprises a chamfer 70, and it is thought advantageous if the chamfer has an angular orientation the same as that of the first land 52.

When installed as described below, it is expected that a fluid tight seal between tapered threaded sprinkler 12 and fitting 10 will be achieved for straight threads 26 without the need for pipe tape or pipe dope.

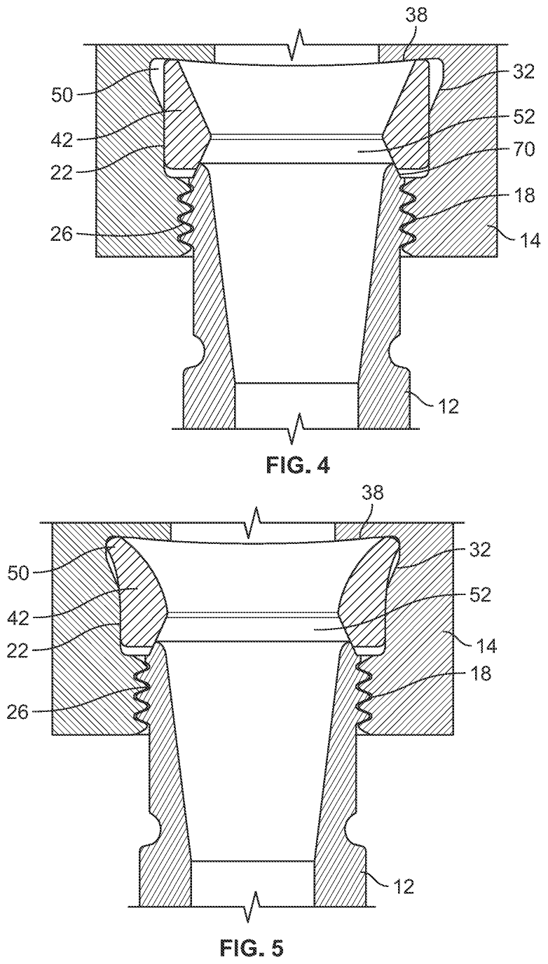

An example method of sealing the tapered threaded sprinkler 12 to the fitting 10 according to the invention begins as shown in FIGS. 1 and 4 by rotating the threaded sprinkler 12 within the straight threaded outlet 18 so as to advance the sprinkler into engagement with the angularly oriented first land 52 of the gasket 42. FIG. 4 shows in detail first contact between the sprinkler 12 and the gasket 42. Note that the chamfer 70 engages the first land 52 at substantially the same orientation angle in this example.

Next, as shown in FIG. 5, rotation of the threaded sprinkler 12 continues so as to compress the gasket 42 both longitudinally within the conduit 14 (compression against shoulder surface 38) and radially outwardly against the inner surface 22 of the conduit. The angular orientation of the first land 52 is responsible for the radial compression of the gasket 42 as the sprinkler 12 advances as is apparent from a resolution of the force vectors at the sprinkler-gasket interface. FIG. 5 illustrates one full turn of the sprinkler 12 after first contact of FIG. 4.

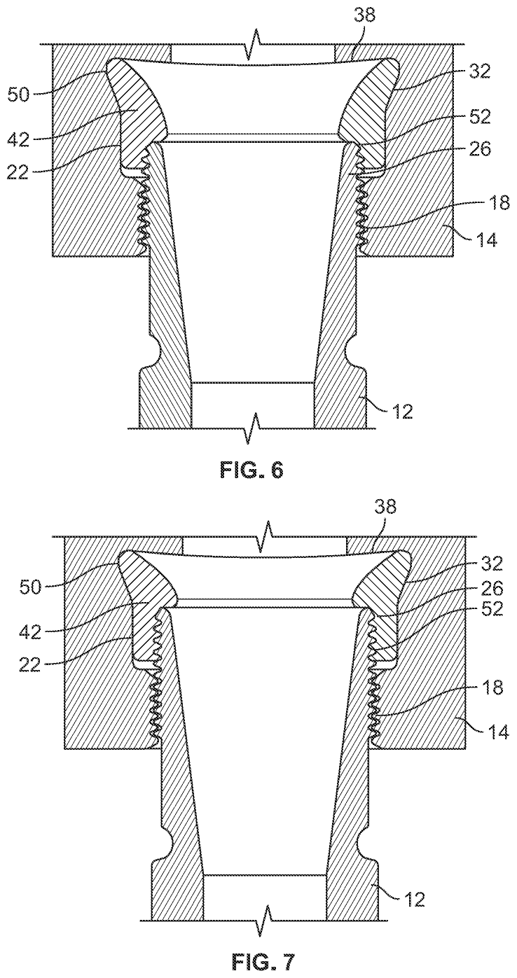

FIG. 6 shows the sprinkler 12 seated within the conduit 14 and in sealing engagement. Note that the gasket 42, being substantially incompressible, has deformed into the redirection space 50 defined by the cone 32 of the inner surface 22. Deformation of the gasket 42 into the redirection space 50 is guided by the angular orientation of shoulder surface 38 against which the gasket is compressed. It is further observed that threads 26 of the sprinkler 12 engage the first land 52 and provide additional sealing effect. FIG. 6 illustrates two full turns of the sprinkler 12 after first contact of FIG. 4.

FIG. 7 shows the sprinkler 12, gasket 42 and conduit 14 at three complete turns after first contact of FIG. 4. While an effective seal is achieved at or before one turn after first contact, it is expected that the fitting 10 and gasket 42 according to the invention will maintain a fluid tight seal up to at least three turns past first contact, and may even provide additional sealing effect in this rotational range. The seal and fitting according to the invention is thus expected to permit advantageous adjustability of the angular position of the sprinkler 12 to effect desired orientation of the frame arms and deflector of the sprinkler without compromising the integrity of the seal. Axial position of the sprinkler relative to the fitting 10 is also adjustable using the seal and fitting according to the invention.

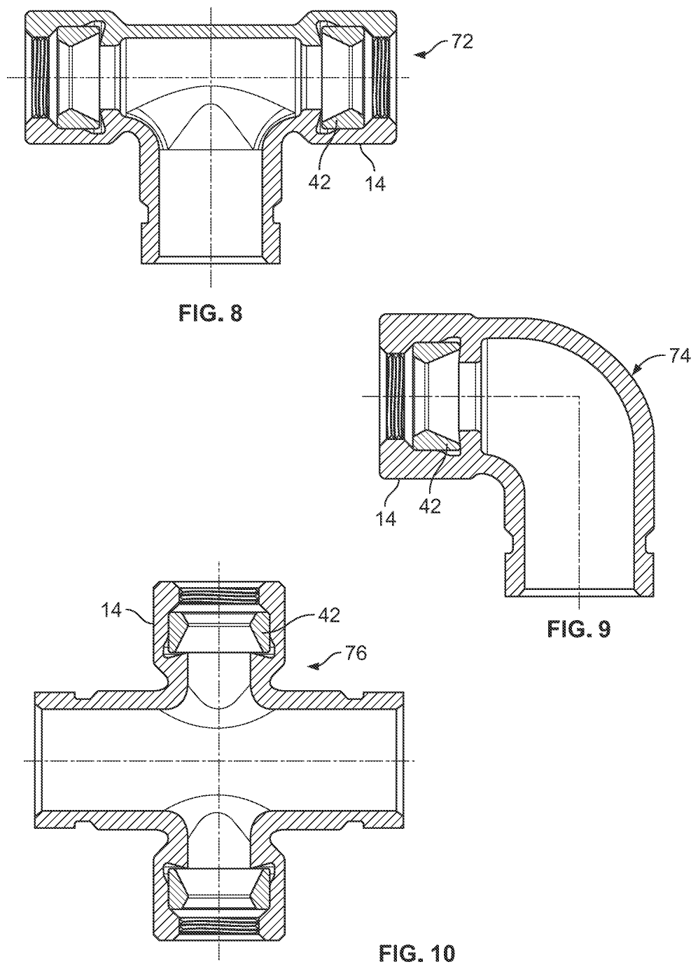

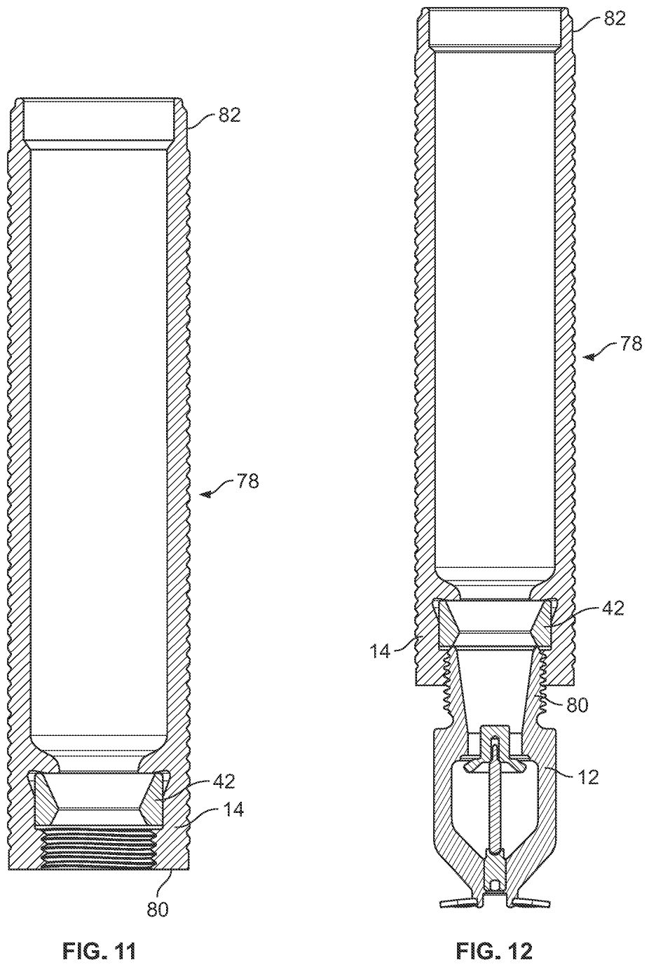

FIGS. 8-12 show additional example embodiments of fittings according to the invention including a Tee 72 having two conduits 14 and gaskets 42 (FIG. 8), a 90° elbow fitting 74 having one conduit 14 and one gasket 42 (FIG. 9), and a cross fitting 76 having two conduits 14 and two gaskets 42 in opposition (FIG. 10). FIG. 11 shows a cross section of a reducer fitting 78 which can receive a sprinkler 12 at one end 80 thereof. The opposite end 82 of reducer fitting 78 may be connected to a flexible conduit.

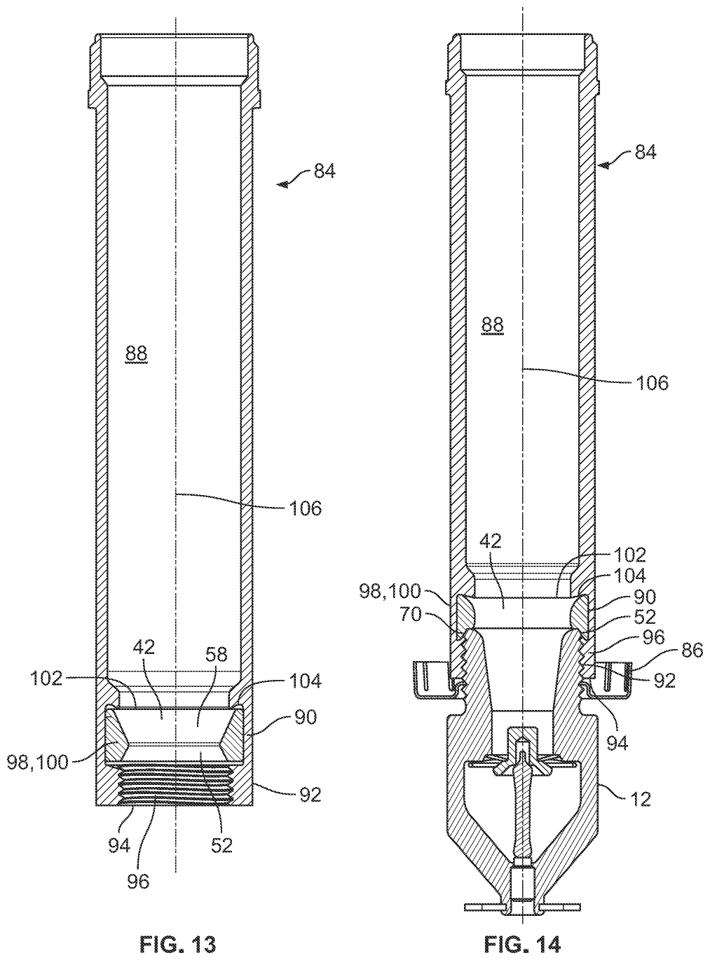

While it is advantageous for the example embodiments of the fittings shown in FIGS. 1-12 to comprise a redirection space 50, the example gasket 42 may be used effectively with fittings having no redirection space. An example embodiment of such a fitting 84 is shown in FIGS. 13 and 14. Example fitting 84 is a reducer fitting which is likely to be used with an escutcheon 86 when receiving a sprinkler 12 as shown in FIG. 14. FIG. 13 shows the reducer 84 wherein an example gasket 42 having lands 52 and 58 as described above is received within the bore 88 of fitting 84. A surface 90, which defines a portion of the bore 88, surrounds the gasket 42. Surface 90 comprises a first portion 92 positioned proximate to an outlet 94 of the fitting 84. Surface portion 92 comprises threads 96 to receive the threaded sprinkler 12 as shown in FIG. 14. Unlike the previously described example embodiments, surface 92 does not comprise a truncated cone portion, but comprises a second portion 98 defining a cylindrical shape 100 positioned between the first portion 92 and an inlet 102. A shoulder surface 104 is positioned at the inlet 102 and projects into the bore 88. Shoulder surface 104 faces the outlet 94 and is oriented transversely and non-perpendicularly with respect to an axis 106 arranged coaxially with the bore 88. Shoulder surface 104 thus provides a dovetail shape to the second portion 98 when viewed in longitudinal section as shown in FIGS. 13 and 14. As shown in FIG. 14, the angular orientation of the shoulder surface 104 guides the deformation behavior of gasket 42 when it is engaged by the sprinkler 12.

FIG. 14 shows the sprinkler 12 sealingly seated against the gasket 42, the sprinkler's chamfer 70 engaging the gasket's first land 52. Gasket 42 is thus compressed against the shoulder surface 104, the gasket being securely fixed between the shoulder surface 104 and the sprinkler 12.

Seals and fittings according to the invention are expected to afford more reliable joints, with less tendency to leak while being usable with both tapered and straight threads without sealing tape or pipe dope. It is further expected that less time and effort will be needed to form the joints, as there will be less preparatory work and less torque is required to secure the components in a fluid-tight manner.

All of the embodiments of the claimed invention described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

What is claimed is:

1. A fitting, said fitting comprising:
a conduit having an inlet and an outlet connected to one another via a bore extending therebetween, said conduit comprising a surface surrounding and defining said bore;
a first portion of said surface positioned proximate to said outlet comprising threads extending along said bore;
a second portion of said surface positioned between said first portion and said inlet defining a truncated cone, a base of said cone being positioned proximate to said inlet, said cone defining a redirection space within said bore;
a shoulder surface positioned at said inlet and projecting into said bore, said shoulder surface facing said outlet and oriented transversely and non-perpendicularly with respect to an axis arranged coaxially with said bore.

2. The fitting according to claim 1, further comprising a third portion of said surface positioned between said first and second portions thereof, said third portion defining a cylindrical shape.

3. The fitting according to claim 1, wherein said threads comprise straight threads.

4. The Fitting according to claim 3, wherein said straight threads comprise NPSL threads.

5. The fitting according to claim 1, wherein said threads comprise tapered threads.

6. The fitting according to claim 1, further comprising a gasket positioned within said bore between said first and second portions of said surface, said gasket comprising an outer surface facing away from said axis and an inner surface facing said axis.

7. The fitting according to claim 6, wherein said outer surface of said gasket has a cylindrical shape.

8. The fitting according to claim 6, wherein said inner surface of said gasket comprises a first land positioned proximate to said first portion of said surface, said first land being angularly oriented with respect to said axis such that an inner diameter of said gasket is greater at a point proximate to said first portion of said surface than a point distal thereto.

9. The fitting according to claim 8, wherein said inner surface of said gasket further comprises a second land positioned proximate to said second portion of said surface, said second land being angularly oriented with respect to said axis such that an inner diameter of said gasket is greater at a point proximate to said inlet than a point distal thereto.

10. The fitting according to claim 9, wherein said second land has a surface area greater than a surface area of said first land.

11. The fitting according to claim 8, further comprising a sprinkler or other fluid control component threadedly received within said bore at said outlet, an end of said sprinkler engaging said first land.

12. The fitting according to claim 11, wherein said sprinkler or other fluid control component comprises straight threads.

13. The fitting according to claim 12, wherein said straight threads comprise NPSL threads.

14. The fitting according to claim 11, wherein said sprinkler or other fluid control component comprises tapered threads.

15. The fitting according to claim 11, wherein said end of said sprinkler comprises a chamfer, said chamfer having an angular orientation the same as that of said first land.

16. The fitting according to claim 11, wherein engagement between said sprinkler and said first land compresses said gasket against said shoulder surface.

17. The fitting according to claim 2, further comprising a gasket positioned within said bore between said first and second portions of said surface, said gasket comprising an outer surface facing away from said axis and an inner surface facing said axis.

18. The fitting according to claim 17, wherein said outer surface of said gasket has a cylindrical shape.

19. The fitting according to claim 18, wherein said outer surface of said gasket has a length greater than a length of said third portion of said surface.

20. The fitting according to claim 1, wherein said fitting comprises a reducer fitting, an elbow fitting, a tee fitting or a cross fitting.

21. A fitting, said fitting comprising:
a conduit having an inlet and an outlet connected to one another via a bore extending therebetween, said conduit comprising a surface surrounding and defining said bore;
a first portion of said surface positioned proximate to said outlet comprising threads extending along said bore;
a second portion of said surface positioned between said first portion and said inlet defining a cylindrical shape;
a shoulder surface positioned at said inlet and projecting into said bore, said shoulder surface facing said outlet and oriented transversely and non-perpendicularly with respect to an axis arranged coaxially with said bore.

22. The fitting according to claim 21, wherein said threads comprise tapered threads.

23. The fitting according to claim 21, wherein said threads comprise straight threads.

24. The Fitting according to claim 23, wherein said straight threads comprise NPSL threads.

25. The fitting according to claim 21, further comprising a gasket positioned within said bore between said first and second portions of said surface, said gasket comprising an outer surface facing away from said axis and an inner surface facing said axis.

26. The fitting according to claim 25, wherein said outer surface of said gasket has a cylindrical shape.

27. The fitting according to claim 25, wherein said inner surface of said gasket comprises a first land positioned proximate to said first portion of said surface, said first land being angularly oriented with respect to said axis such that an inner diameter of said gasket is greater at a point proximate to said first portion of said surface than a point distal thereto.

28. The fitting according to claim 27, wherein said inner surface of said gasket further comprises a second land positioned proximate to said second portion of said surface, said second land being angularly oriented with respect to said axis such that an inner diameter of said gasket is greater at a point proximate to said inlet than a point distal thereto.

29. The fitting according to claim 28, wherein said second land has a surface area greater than a surface area of said first land.

30. The fitting according to claim 27, further comprising a sprinkler or other fluid control component threadedly received within said bore at said outlet, an end of said sprinkler engaging said first land.

31. The fitting according to claim 30, wherein said sprinkler or other fluid control component comprises straight threads.

32. The fitting according to claim 31, wherein said straight threads comprise NPSL threads.

33. The fitting according to claim 30, wherein said sprinkler or other fluid control component comprises tapered threads.

34. The fitting according to claim 30, wherein said end of said sprinkler comprises a chamfer, said chamfer having an angular orientation the same as that of said first land.

35. The fitting according to claim 30, wherein engagement between said sprinkler and said first land compresses said gasket against said shoulder surface.

36. The fitting according to claim 21, wherein said fitting comprises a reducer fitting.

37. The fitting according to claim 36, further comprising an escutcheon positioned at said outlet of said fitting.

38. A method of sealing a threaded sprinkler to a fitting defining a conduit having a threaded outlet using a gasket positioned within said conduit, said method comprising:
rotating said threaded sprinkler within said threaded outlet so as to advance said sprinkler into engagement with an angularly oriented land of said gasket;
continue rotating said threaded sprinkler so as to compress said gasket both longitudinally within said conduit and radially outwardly against said conduit.

39. The method according to claim 38, further comprising engaging threads of said threaded sprinkler with said land.
